(19) United States
(12) Patent Application Publication
(10) Pub. No.: US 2006/0278614 A1
(43) Pub. Date: Dec. 14, 2006

(54) Polishing composition and method for defect improvement by reduced particle stiction on copper surface

(75) Inventors: Yuchun Wang, Naperville, IL (US); Fred F. Sun, Naperville, IL (US); Joseph D. Hawkins, Oswego, IL (US)

Correspondence Address: STEVEN WESEMAN;ASSOCIATE GENERAL COUNSEL, I.P., CABOT MICROELECTRONICS CORPORATION, 870 NORTH COMMONS DRIVE, AURORA, IL, 60504, US

(73) Assignee: Cabot Microelectronics Corporation, Aurora, IL (US)

(21) Appl. No.: 11/147,531

(22) Filed: Jun. 8, 2005

(51) Int. Cl. C09K 13/00; C09K 13/06; B44C 1/22; C03C 25/68

(52) U.S. Cl. 216/89; 252/79.1; 252/79.4; 216/92

(57) ABSTRACT

A chemical-mechanical polishing composition comprising abrasive particles, a hydroxyquinoline, and a diamine compound comprising an ether group, and a method of chemically-mechanically polishing a substrate with the aforementioned polishing composition.

### FIELD OF THE INVENTION

This invention pertains to a polishing composition and a method for polishing a substrate using the same.

### BACKGROUND OF THE INVENTION

Compositions and methods for planarizing or polishing the surface of a substrate, especially for chemical-mechanical polishing (CMP), are well known in the art. Polishing compositions (also known as polishing slurries) used in CMP processes typically contain an abrasive material in an aqueous solution, and are applied to a surface by contacting the surface with a polishing pad saturated with the polishing composition. Typical abrasive materials include silicon dioxide, cerium oxide, aluminum oxide, zirconium oxide, and tin oxide. The polishing composition is generally used in conjunction with a polishing pad (e.g., polishing cloth or disk). The polishing pad may contain abrasive material in addition to, or instead of, the abrasive material in the polishing composition.

Polishing compositions for silicon dioxide based inter-metal dielectric layers have been particularly well developed in the semiconductor industry and the chemical and mechanical nature of polishing and wear of the silicon dioxide based dielectrics is reasonably well understood. One problem with the silicon dioxide-based dielectric materials, however, is that their dielectric constant is relatively high, being approximately 3.9 or higher, depending on factors such as residual moisture content. As a result, the capacitance between the conductive layers is also relatively high, which in turn limits the speed (frequency) at which a circuit can operate. Strategies being developed to increase the frequency at which the circuit can operate include (1) incorporating metals with lower resistivity values (e.g., copper), and (2) providing electrical isolation with insulating materials having lower dielectric constants relative to silicon dioxide.

One way to fabricate planar copper circuit traces on a silicon dioxide substrate is referred to as the damascene process. In accordance with this process, the silicon dioxide dielectric surface is patterned by a conventional dry etch process to form trenches and holes for horizontal and vertical interconnects. The patterned surface is coated with an adhesion-promoting layer such as tantalum or titanium and/or a diffusion barrier layer such as tantalum nitride or titanium nitride. The adhesion-promoting layer and/or the diffusion barrier layer are then over-coated with a copper layer. Chemical-mechanical polishing is employed to reduce the thickness of the copper over-layer, as well as the thickness of any adhesion-promoting layer and/or diffusion barrier layer, until a planar surface that exposes elevated portions of the silicon dioxide surface is obtained. The trenches and vias remain filled with electrically conductive copper forming the circuit interconnects.

The first step in copper CMP is to remove the bulk of the copper, typically stopping on the underlying Ta/TaN diffusion barrier. At this point, since tantalum has quite different polishing properties than copper, it is often desirable to switch to a different polishing slurry and perhaps a different polishing pad in an effort to obtain high selectivity between the barrier and copper. This is particularly important in cases where the copper thickness is not uniform across the wafer, leading to areas where the barrier is exposed for long periods of time while the thicker areas of copper continue to be polished. The time from when the diffusion barrier is first exposed to when the last remaining copper is cleared is called the overpolish time. Selectivity for copper over the barrier layer is desirable so that, during the overpolish time, the barrier layer is not excessively removed, contributing to dishing and nonplanarity.

Previously, it was believed that both the removal rate of the copper and the removal rate of the adhesion-promoting layer and/or the diffusion barrier layer must greatly exceed the removal rate of silicon dioxide so that polishing effectively stops when elevated portions of the silicon dioxide are exposed. The ratio of the removal rate of copper to the removal rate of silicon dioxide base is called “selectivity.” A minimum selectivity of about 50 was desired for such chemical-mechanical polishing. However, when high selectivity copper slurries are used, the copper layers are easily over-polished creating a depression or “dishing” effect in the copper vias and trenches. This feature distortion is unacceptable due to resistance variability and other constraints in semiconductor manufacturing. Another feature distortion that is unsuitable for semiconductor manufacturing is called “erosion.” Erosion is the loss of dielectric material between a field of silicon oxide and a dense array of copper vias or trenches. In chemical-mechanical polishing, the materials in the dense array are often removed or eroded at a faster rate than the surrounding field of silicon oxide. This causes a topography difference between the field of silicon oxide and the dense copper array. The industry standard for erosion is typically less than 500 Angstroms (Å). The build-up of topography caused by dishing and erosion on multiple layers can lead to an increased incidence of metal line shorts and opens in the upper metal layers which can result in reduced device yield.

Dishing is mainly a result of chemical attack assisted by mechanical forces, such as flex in the polishing pad combined with abrasive gouging. One way to reduce dishing is to reduce the mechanical forces, typically by reducing the down force applied to the polishing pad during polishing of copper substrates. However, as polishing down force is reduced, adhesion, or stiction, of abrasive particles to the polished copper surface becomes more significant. Residual abrasive particles lead to difficulties such as complicating post-polishing cleaning, masking of other defects during defect inspection, and contributing to potential scratching during barrier polishing.

As a consequence of these and other issues, there remains a need for other polishing compositions and polishing methods. The invention provides such a composition and method. The advantages and inventive features of the invention will be apparent from the description of the invention provided herein.

### BRIEF SUMMARY OF THE INVENTION

The polishing composition of the invention comprises abrasive particles, a hydroxyquinoline, and a diamine compound comprising an ether group. The invention further provides a method of polishing a substrate comprising (a) contacting a surface of a substrate with a polishing pad, (b) supplying a polishing composition between the surface of the substrate and the polishing pad, wherein the polishing composition comprises abrasive particles, hydroxyquinoline, and a diamine compound comprising an ether group, and (c) moving the polishing pad relative to the surface of the substrate to remove a portion of the substrate, thereby polishing the substrate.

### DETAILED DESCRIPTION OF THE INVENTION

The polishing composition of the invention comprises abrasive particles, a hydroxyquinoline, and a diamine compound comprising an ether group.

Any suitable hydroxyquinoline can be used in conjunction with the invention. Hydroxyquinoline is a derivative of quinoline, which is a fused ring compound comprising a six-membered nitrogen-containing ring (e.g., a pyridine ring) and a six-membered carbon ring. The nitrogen atom is located adjacent to a ring junction and is typically designated as position (1) on the quinoline ring system. Hydroxyquinoline is quinoline substituted with a hydroxy group at any available position of the quinoline ring system. Suitable hydroxyquinolines for use in conjunction with the invention can have any suitable substituent(s) in addition to the hydroxy group. These additional substituent(s) can be bonded to the hydroxyquinoline ring system at any available position. Preferably, the hydroxyquinoline is 8-hydroxyquinoline.

The polishing composition can comprise any suitable amount of a hydroxyquinoline. While any suitable amount of hydroxyquinoline can be used, the polishing composition of the invention will typically comprise about 0.001 wt. % or more (e.g., about 0.002 wt. % or more, or about 0.005 wt. % or more, or about 0.01 wt. % or more) of the hydroxyquinoline based on the total weight of the polishing composition. Generally, the polishing composition will comprise about 0.2 wt. % or less (e.g., about 0.1 wt. % or less, or about 0.05 wt. % or less, or even about 0.02 wt. % or less) of the hydroxyquinoline based on the total weight of the polishing composition. Of course, any of the above amounts expressed in terms of desirable upper and lower limits also can be expressed as ranges (e.g., about 0.001 wt. % to about 0.2 wt. %, about 0.001 wt. % to about 0.1 wt. %, about 0.005 wt. % to about 0.02 wt. %, etc.) based on the total weight of the polishing composition.

Any suitable diamine compound comprising an ether group can be used in conjunction with the invention. A diamine compound, as used herein, is any compound comprising two nitrogen atoms which provide two amine groups. The nitrogen atoms can have any suitable spatial arrangement within the diamine compound. For example, the nitrogen atoms can be bonded directly to each other, or an intervening group of atoms can separate the nitrogen atoms. Further, the nitrogen atoms, independently or together, can be part of an acyclic chain, or form part of a ring structure.

Each nitrogen atom forming the amine group, independently, can be unsubstituted (e.g., —NH₂ or —NH₃⁺) or substituted (e.g., with one or more carbon-containing or hetero-atom containing groups). Depending on the number of atoms to which each nitrogen atom is bonded, the nitrogen atoms can be charged or uncharged. Of course, when a nitrogen atom assumes a quaternary configuration (e.g., is bound to four atoms), the nitrogen atom bears a positive charge. Thus, the diamine compound can exist as a free base (e.g., wherein both nitrogen atoms are unprotonated), a mono addition salt of an acid (e.g., wherein only one nitrogen atom is protonated), or a bis addition salt of an acid (e.g., wherein both nitrogen atoms are protonated). Accordingly, the diamine compound may further comprise one or more counter-ions as appropriate.

The diamine compound comprises at least one ether group, and can comprise more than one ether group (e.g., a polyether diamine). Also, the diamine compound comprising at least one ether group (e.g., two or more ether groups) can be derived from the combination of two, three, or more monomeric units, such as ethylene oxide or propylene oxide, to provide a linear diamine polyether. Preferably, the diamine compound comprising an ether group is a polyether diamine. More preferably, the diamine compound comprising an ether group is a trioxa-tridecane diamine. A trioxa-tridecane diamine is a compound comprising a 13-atom linear chain having three oxygen atoms and two nitrogen atoms incorporated into the linear chain. The trioxa-tridecane diamine can be further substituted at any available position with one or more suitable substituent groups. An example of a trioxa-tridecane diamine suitable for use in conjunction with the invention is 4,7,10-trioxa-1,13-tridecane diamine.

The polishing composition can comprise any suitable amount of the diamine compound comprising an ether group. Typically, the polishing composition comprises about 0.05 wt. % or more, (e.g., about 0.1 wt. % or more, or even about 0.2 wt. % or more) of the diamine compound comprising an ether group based on the total weight of the polishing composition. Generally, the polishing composition comprises about 5 wt. % or less (e.g., about 2 wt. % or less, or even about 1 wt. % or less, or about 0.5 wt. % or less) of the diamine compound comprising an ether group based on the total weight of the polishing composition. Of course, any of the above amounts expressed in terms of desirable upper and lower limits can also be expressed as ranges (e.g., about 0.05 wt. % to about 5 wt. %, about 0.05 wt. % to about 2 wt. %, about 0.1 wt. % to about 1 wt. %, etc.) based on the total weight of the polishing composition.

Any suitable abrasive particles can be used in conjunction with the invention, many of which abrasive particles are well known in the art. Desirably, the abrasive particles are metal oxide abrasive particles, such as silica particles, alumina particles, ceria particles, mixed oxides thereof, or combinations thereof. The metal oxide abrasive particles can be fumed metal oxide particles, or metal oxide particles prepared by some other method (e.g., sol-gel, condensation-polymerization, precipitation, etc.). Preferred abrasive particles are alumina, preferably fumed alumina. Such abrasive particles can be prepared in accordance with U.S. Pat. No. 5,230,833, or can be obtained as any of various commercially available products, such as the Akzo-Nobel Bindzil 50/80 product and the Nalco 1050, 2327, and 2329 products, as well as other similar, commercially-available products.

The abrasive particles can have any suitable average particle diameter. The term “average particle diameter” as used herein refers to the average (by number) spherical diameter of the abrasive particles, wherein “spherical diameter” is the diameter of the smallest sphere that completely encompasses a particle. In one embodiment, the abrasive particles are colloidal particles. Colloidal particles, in accordance with the invention, have an average particle diameter of about 1 nm to about 1000 nm (e.g., about 5 nm to about 800 nm, such as about 10 nm to about 500 nm, or about 20 nm to about 300 nm). According to another embodiment, the abrasive particles have an average particle diameter of about 40 nm or less (e.g., about 1 to about 40 nm, such as about 5 nm to about 30 nm, or about 10 nm to about 20 nm). In yet another embodiment, the abrasive particles have an average particle diameter of about 40 nm or more (e.g., about 40 nm to about 2000 nm, such as about 60 nm to about 1000 nm, or about 80 nm to about 500 nm).

Some abrasive particles, such as fumed metal oxide abrasive particles, comprise small primary particles that are fused together to form larger, chain-like aggregate particles. Considerable force is required to break these aggregate particles into primary particles. For example, the aggregate particles do not break down under normal dispersion forces. This differentiates aggregate particles from agglomerate particles, which are formed by the relatively loose association of aggregate particles with one another. When the abrasive particles are provided by aggregate particles, such as fumed metal oxide particles, the particle size referred to herein relates to the size of the aggregate particle, not the size of the primary particles that are fused together to make up the aggregate. Thus, the average spherical diameter of a fumed metal oxide particle, for example, is the diameter of the smallest sphere that encompasses the aggregate particle.

The polishing composition can comprise any suitable amount of abrasive particles. Typically, the polishing composition comprises about 0.1 wt. % or more (e.g., about 0.5 wt. % or more, such as about 1 wt. % or more) abrasive particles based on the total weight of the polishing composition. For most applications, the amount of abrasive particles in the polishing composition generally will not exceed about 20 wt. %, and will usually be about 10 wt. % or less (e.g., about 5 wt. % or less, or about 3 wt. % or less) based on the total weight of the polishing composition. Of course, any of the above amounts expressed in terms of optional upper and lower limits also can be expressed as ranges (e.g., about 0.1 wt. % to about 10 wt. %, about 0.1 wt. % to about 5 wt. %, about 0.5 wt. % to about 5 wt. %, etc.) based on the total weight of the polishing composition.

The polishing composition generally comprises a liquid carrier in addition to the hydroxyquinoline, diamine compound comprising an ether, abrasive particles, and any other components. The liquid carrier can be an aqueous carrier, such as water and/or a water-miscible solvent. Suitable water-miscible solvents include alcohols such as methanol, ethanol, and the like. Non-aqueous solvents or emulsions also can be used as the carrier; however, aqueous carriers, such as water, are preferred.

The abrasive particles can be suspended in the polishing composition, more specifically in the liquid carrier of the polishing composition, and preferably provide a colloidally stable suspension. In the context of the invention, an abrasive suspended in a polishing composition is considered colloidally stable if, after being allowed to stand unagitated in a 100 ml graduated cylinder for 2 hours, the difference between the concentration of particles in the bottom 50 ml of the graduated cylinder ([B] in terms of g/ml) and the concentration of particles in the top 50 ml of the cylinder ([T] in terms of g/ml) divided by the initial concentration of particles in the abrasive composition ([C] in terms of g/ml) is less than or equal to 0.5 (i.e., {[B]−[T]}/[C]≦0.5). The value of [B]−[T]/[C] desirably is less than or equal to 0.3, and preferably is less than or equal to 0.1.

The polishing composition optionally comprises an oxidizing agent for the surface (e.g., metal surface) being polished. Preferably, the oxidizing agent oxidizes copper (e.g., a copper oxidizing agent). Suitable oxidizing agents include inorganic and organic per-compounds, bromates, nitrates, chlorates, chromates, iodates, iron and copper salts (e.g., nitrates, sulfates, EDTA salts, and citrates), rare earth and transition metal oxides (e.g., osmium tetra-oxide), potassium ferricyanide, potassium dichromate, iodic acid, and the like. A per-compound is a compound comprising at least one peroxy group (—O—O—), or a compound comprising an element in its highest oxidation state and one or more oxygen atoms. Examples of compounds containing at least one peroxy group include, but are not limited to, hydrogen peroxide and its adducts, such as urea hydrogen peroxide and percarbonates, organic peroxides such as benzoyl peroxide, peracetic acid, and di-tert-butyl peroxide, monopersulfates (SO₅²⁻), dipersulfates (S₂O₈²⁻), and sodium peroxide. Examples of compounds comprising an element in its highest oxidation state and one or more oxygen atoms include, but are not limited to, periodic acid, periodate salts, perbromic acid, perbromate salts, perchloric acid, perchlorate salts, perboric acid, perborate salts, and permanganates. Hydrogen peroxide is a preferred oxidizing agent. The polishing composition typically comprises about 0.1 wt. % to about 15 wt. % (e.g., about 0.2 wt. % to about 10 wt. %, about 0.5 wt. % to about 8 wt. %, or about 1 wt. % to about 5 wt. %) of an oxidizing agent based on the total weight of the polishing composition.

The polishing composition optionally comprises a corrosion inhibitor, preferably a copper-corrosion inhibitor. For the purposes of this invention, a corrosion inhibitor is any compound, or mixture of compounds, that facilitates the formation of a passivation layer (i.e., a dissolution-inhibiting layer) on at least a portion of the surface being polished. A copper-corrosion inhibitor is any compound that facilitates the formation of a passivation layer on copper. Useful copper-corrosion inhibitors include, for example, nitrogen-containing heterocyclic compounds. The corrosion inhibitor desirably comprises one or more 5- or 6-membered, heterocyclic, nitrogen-containing rings. Preferred corrosion inhibitors include 1,2,3-triazole, 1,2,4-triazole, benzotriazole, benzimidazole, benzothiazole, and derivatives thereof, such as, for example, hydroxy-, amino-, imino-, carboxy-, mercapto-, nitro-, urea-, thiourea-, or alkyl-substituted derivatives thereof. Most preferably, the corrosion inhibitor is selected from the group consisting of benzotriazole (BTA), 1,2,3-triazole, 1,2,4-triazole, and mixtures thereof. The polishing composition of the invention can comprise any suitable amount of the corrosion inhibitor. Generally, the polishing composition comprises about 0.005 wt. % to about 1 wt. % (e.g., about 0.01 to about 0.5 wt. %, or about 0.02 to about 0.2 wt. %) of the corrosion inhibitor based on the total weight of the polishing composition.

The polishing composition optionally comprises a complexing agent (e.g., chelating agent). A complexing agent is any compound capable of forming a complex with metal ions, especially copper ions. In this way, the complexing agent can increase the solubility and/or reduce the degree to which metal ions precipitate or redeposit onto the surface of a metal substrate being polished. Suitable complexing agents include, for example, organic acids, carbonyl compounds (e.g., acetylacetonates and the like), di-, tri-, and polyalcohols (e.g., ethylene glycol, pyrocatechol, pyrogallol, tannic acid, and the like), and amine-containing compounds (e.g., ammonia, amino acids, amino alcohols, di-, tri-, and polyamines, and the like). Preferably, the complexing agent is an organic acid. Non-limiting examples of organic acids suitable for use as complexing agents in the context of the invention include tartaric acid, citric acid, malonic acid, succinic acid, maleic acid, phthalic acid, malic acid, lactic acid, salicylic acid, anthranilic acid, glycolic acid, lauric acid, pyruvic acid, salts thereof, and combinations thereof. A preferred complexing agent is tartaric acid. The polishing composition typically comprises about 0.01 wt. % to about 10 wt. %, such as about 0.05 wt. % to about 5 wt. %, or about 0.1 wt. % to about 1 wt. %, of the complexing agent based on the total weight of the polishing composition.

The polishing composition optionally comprises a polymer. The polymer can have one or more functions in the polishing composition, such as to reduce the polishing rate with respect to one or more materials, to act as a dispersant, to stabilize the polishing composition, to modify the viscosity of the polishing composition, to assist in removing the products of polishing from the surface being polished, or any other function that serves to improve polishing performance. The choice of a particular polymer will depend upon the specific application and the desired characteristics of the polishing composition. Especially useful polymers include those comprising carboxylic acid functional groups, such as polyacrylic acids and polymethacrylic acids. The polymer can be present in any suitable amount. Typically, the polishing composition will comprise about 0.01 wt. % to about 10 wt. %, such as about 0.1 wt. % to about 1 wt. %, of the polymer based on the total weight of the polishing composition.

The polishing composition can have any suitable pH. Desirably, the polishing composition will have a pH of about 7 or more, or a pH of about 8 or more (e.g., a pH of about 7 to about 12, or a pH of about 8 to about 1 1). The pH of the chemical-mechanical polishing system can be achieved and/or maintained by any suitable means. For example, the polishing composition can comprise a pH adjustor, a pH buffering agent, or a combination thereof as needed to achieve or maintain a desired pH. Suitable pH adjustors include potassium hydroxide, sodium hydroxide, ammonium hydroxide, or a combination thereof. Suitable buffering agents include phosphates, acetates, borates, ammonium salts, and the like.

The polishing composition optionally comprises an antifoaming agent. The anti-foaming agent can be any suitable anti-foaming agent. Suitable antifoaming agents include, but are not limited to, silicon-based and acetylenic diol-based antifoaming agents. The amount of anti-foaming agent present in the CMP system (particularly the polishing composition) typically is about 40 ppm to about 140 ppm, based on the total weight of the polishing composition.

The polishing composition optionally comprises a biocide. The biocide can be any suitable biocide, such as an isothiazolinone biocide. The amount of biocide used in the CMP system (particularly the polishing composition) typically is about I to about 200 ppm, such as about 10 to about 100 ppm, based on the total weight of the polishing composition.

The polishing composition can be prepared by in any suitable manner. Generally, the polishing composition can be prepared by combining and mixing the components thereof in a batch or continuous process. Furthermore, the polishing composition can be prepared in-whole or in-part prior to use, or each of the individual components of the polishing composition can be separately stored and combined immediately prior to or during use. When the polishing composition is prepared in-part prior to use, one or more components of the polishing composition, such as an optional oxidizing agent, can be added to the polishing composition just before or during use (e.g., within about 1 minute before use, or within about 1 hour before use, or within about 7 days before use). When all or some of the components of the polishing composition are separately stored and combined during use, the components can be delivered to the surface of the substrate being polished, where the components are combined and mixed to provide the polishing composition. The pH of the polishing composition or any one or more of its components can be adjusted at any suitable time.

The polishing composition of the invention can be supplied as a single package (e.g., container) comprising all of the components of the polishing composition, or the polishing composition can be supplied as a multi-package system with each package comprising one or more components of the polishing composition that are combined prior to use. For example, when supplied as a multi-package system, a first package can comprise all of the components of the polishing composition except for the optional oxidizing agent and optionally a portion of the liquid carrier. The oxidizing agent can be placed in a second package either in pure form or in a mixture with all or a portion of the liquid carrier, e.g., water, for the polishing composition. The oxidizing agent is combined, e.g., by the end-user, with the other components of the polishing composition shortly before use (e.g., 1 week or less prior to use, 1 day or less prior to use, 1 hour or less prior to use, 10 minutes or less prior to use, or 1 minute or less prior to use). Other multi-package configurations (e.g., two-, three-, or more-package configurations) of the polishing composition are contemplated by the invention.

Whether provided as a single-package or multi-package system, the polishing composition can be provided as a concentrate which is intended to be diluted with an appropriate amount of water or other diluent prior to use. In such an embodiment, the polishing composition concentrate can comprise abrasive particles, a hydroxyquinoline, and a diamine compound comprising an ether group, as well as any other optional components, in amounts such that, upon dilution of the concentrate with an appropriate dilutant (e.g., water), each component of the polishing composition will be present in the polishing composition in the desired amount.

The invention also provides a method of polishing a substrate using the polishing composition of the invention. In particular, the method of the invention comprises (a) contacting a surface of a substrate with a polishing pad, (b) supplying a polishing composition between the surface of the substrate and the polishing pad, wherein the polishing composition comprises abrasive particles, a hydroxyquinoline, and a diamine compound comprising an ether group and (c) moving the polishing pad relative to the surface of the substrate to remove a portion of the substrate, thereby polishing the substrate. The polishing of the substrate desirably effects the planarization of the substrate. The polishing composition useful in conjunction with the method of the invention is as previously described herein.

The method of the invention is particularly well-suited for use in conjunction with a chemical-mechanical polishing (CMP) apparatus. Typically, the apparatus comprises a platen, which, when in use, is in motion and has a velocity that results from orbital, linear, or circular motion, a polishing pad in contact with the platen and moving with the platen when in motion, and a carrier that holds a substrate to be polished by contacting and moving relative to the surface of the polishing pad. The polishing of the substrate takes place by the substrate being placed in contact with the polishing pad and the polishing composition of the invention, and by the polishing pad moving relative to the substrate so as to abrade and remove a portion of the substrate so as to polish at least a portion of the substrate.

A substrate can be polished with the polishing composition and any suitable polishing pad (e.g., polishing surface). Suitable polishing pads include, for example, woven and non-woven polishing pads. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, coformed products thereof, and mixtures thereof.

Desirably, the CMP apparatus further comprises an in situ polishing endpoint detection system, many of which are known in the art. Techniques for inspecting and monitoring the polishing process by analyzing light or other radiation reflected from a surface of the substrate are known in the art. Desirably, the inspection or monitoring of the progress of the polishing process with respect to a substrate being polished enables the determination of the polishing end-point, i.e., the determination of when to terminate the polishing process with respect to a particular substrate.

The polishing composition and method of the invention can be used to polish any substrate (e.g., an integrated circuit, metals, ILD layers, semiconductors, thin films, MEMS, magnetic heads), and are particularly useful for polishing a substrate comprising a metal such as copper. The polishing composition and method of the invention are also useful for polishing multi-layered substrates, such as a substrate comprising a metal layer such as copper, and one or more layers of material other than copper, such as an insulating layer, additional conductive layers (e.g., other metal or metal alloy layers), or barrier layers (e.g., a tantalum barrier layer). Insulating layers include those comprising a metal oxide (e.g., porous metal oxide), glass, organic polymer (e.g., fluorinated organic polymer), or any other suitable high or low-κ insulating layer. Preferably, the substrate comprises copper and a barrier layer such as tantalum.

When used to polish copper, the polishing composition of the invention desirably provides for reduced adhesion of abrasive particles to the copper surface being polished, and for increased selectivity for the polishing of copper over any barrier layer that may be present, especially a tantalum barrier layer. Without wishing to be bound by any particular theory, it is believed that, when used to polish a copper-containing substrate, the hydroxyquinoline functions to reduce adhesion of abrasive particles to the polished copper surface. Further, when used to polish a substrate comprising a tantalum-containing barrier layer, the diamine compound comprising an ether group is believed to suppress the removal of the tantalum barrier, thereby minimizing erosion of the underlying dielectric material/layer.

### EXAMPLES

The following examples further illustrate the invention but, of course, should not be construed as in any way limiting its scope.

In the Examples below, the polishing experiments were performed using a 20 cm (8 inch) diameter polishing tool with 6.9 kPa (1 psi) down force pressure against a concentrically grooved polishing pad, 103 rpm platen speed, 97 rpm carrier speed, 200 mL/min polishing composition flow rate, and use of in-situ pad conditioning.

### Example 1

This example demonstrates that the invention can be used to reduce defectivity and abrasive particle stiction during the polishing of blanket-copper surfaces.

In this example, substrates comprising a blanket layer of copper were polished with one of two different polishing compositions (Polishing Compositions 1A and 1B). Polishing Compositions 1A and 1B each contained 1 wt. % alumina, 1 wt. % hydrogen peroxide, 0.1 wt. % 1,2,4-triazole, 0.1 wt. % 4,7,1 0-trioxatridecane diamine (TTD), and 1 wt. % tartaric acid in water at a pH of 8.5. In addition, polishing Composition 1B (invention) contained 0.025 wt. % 8-hydroxyquinoline.

The total defect count was determined for each substrate using a KLA Tencor SP1 DWO instrument. The total defect count includes defects caused by factors other than particle stiction. The presence of abrasive particles on the substrate surface was determined visually with optical microscopy. The results are summarized in Table 1.

TABLE 1

| | | | Total | Optical |
|---|---|---|---|---|
| Polishing | 8-hydroxyquinoline | TTD | Defect | Microscopy |
| Composition | (wt. %) | (wt. %) | Count* | Inspection |
| 1A | none | 0.1 | 15616 | Particles |
| (comparative) | | | | observed |
| 1B | 0.025 | 0.1 | 381 | No particles |
| (invention) | | | | observed |

*Total defect count includes defects other than particle stiction.

As is apparent from the results set forth in Table 1, the addition of 8-hydroxyquinoline (Polishing Composition 1 B) reduced the total defect count by approximately 98%, and greatly reduced particle stiction, as compared to the polishing composition without 8-hydroxyquinoline (Polishing Composition 1A).

### Example 2

This example demonstrates that the invention can be used to reduce defectivity and abrasive particle stiction during the polishing of patterned copper-containing substrates.

Substrates comprising copper overlaid onto patterned wafers were polished with one of three different polishing compositions (Polishing Compositions 2A, 2B, and 2C). Each of the Polishing Compositions 2A, 2B, and 2C contained 1 wt. % alumina, 1 wt. % hydrogen peroxide, 0.1 wt. % 1,2,4-triazole, 0.1 wt. % 4,7,10-trioxatridecane diamine (TTD), and 1 wt. % tartaric acid in water at a pH of 8.5. In addition, Polishing Composition 1B (invention) contained 0.01 wt. % 8-hydroxyquinoline, and Polishing Composition 2C (invention) contained 0.015 wt. % 8-hydroxyquinoline.

The total defect count was determined for each substrate using a KLA Tencor AIT instrument. The total defect count includes defects caused by factors other than particle stiction. The presence of abrasive particles on the substrate surface was determined visually with optical microscopy. The results are summarized in Table 2.

TABLE 2

| | | | Total | Optical |
|---|---|---|---|---|
| Polishing | 8-hydroxyquinoline | TTD | Defect | Microscopy |
| Composition | (wt. %) | (wt. %) | Count | Inspection |
| 2A | none | 0.1 | >25000 | Particles |
| (comparative) | | | | observed |
| 2B | 0.01 | 0.1 | 5883 | Few particles |
| (invention) | | | | observed |
| 2C | 0.015 | 0.1 | 482 | Few/no |
| (invention) | | | | particles |
| | | | | observed |

* Total defect count includes defects other than particle stiction.

As is apparent from the results set forth in Table 2, the addition of 0.01 wt. % 8-hydroxyquinoline (Polishing Composition 2B) reduced the average total defect count by approximately 75%, and reduced particle stiction, as compared to the polishing composition without 8-hydroxyquinoline (Polishing Composition 2A). Increasing the amount of 8-hydroxyquinoline from 0.01 wt. % (Polishing Composition 2B) to 0.015% (Polishing Composition 2C) increased the effectiveness of the polishing composition, reducing the average total defect count by approximately 98% as compared to the polishing composition without 8-hydroxyquinoline (Polishing Composition 2A), and further reducing particle stiction.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A polishing composition comprising abrasive particles, a hydroxyquinoline, and a diamine compound comprising an ether group.

2. The polishing composition of claim 1, wherein the hydroxyquinoline is 8-hydroxyquinoline.

3. The polishing composition of claim 1 comprising about 0.001-0.2 wt. % of a hydroxyquinoline.

4. The polishing composition of claim 3 comprising about 0.005-0.02 wt. % of a hydroxyquinoline.

5. The polishing composition of claim 1, wherein the diamine compound comprising an ether group is a polyether diamine.

6. The polishing composition of claim 5, wherein the diamine compound comprising an ether group is a trioxa-tridecane diamine.

7. The polishing composition of claim 6, wherein the diamine compound comprising an ether group is 4,7,10-trioxa-1,13-tridecane diamine.

8. The polishing composition of claim 1 comprising about 0.05-5 wt. % of the diamine compound comprising an ether group.

9. The polishing composition of claim 8 comprising about 0.1-1 wt. % of the diamine compound comprising an ether group.

10. The polishing composition of claim 1 comprising about 0.001-0.2 wt. % 8-hydroxyquinoline and about 0.05-5 wt. % 4,7,10-trioxa-1,13-tridecane diamine.

11. The polishing composition of claim 10 comprising about 0.005-0.02 wt. % 8-hydroxyquinoline and about 0.1-1 wt. % 4,7,10-trioxa-1,13-tridecane diamine.

12. The polishing composition of claim 1 comprising about 0.1-5 wt. % abrasive particles.

13. The polishing composition of claim 12, wherein the abrasive particles are metal oxide abrasive particles.

14. The polishing composition of claim 13, wherein the abrasive particles are selected from the group consisting of silica particles, alumina particles, and ceria particles.

15. The polishing composition of claim 14, wherein the abrasive particles are condensation-polymerized silica particles.

16. The polishing composition of claim 1, wherein the abrasive particles have an average particle diameter of about 40 nm or less.

17. The polishing composition of claim 1, wherein the abrasive particles have an average particle diameter of greater than 40 nm.

18. The polishing composition of claim 1 further comprising an oxidizing agent.

19. The polishing composition of claim 18, wherein the oxidizing agent is hydrogen peroxide.

20. The polishing composition of claim 1 further comprising a corrosion inhibitor for copper.

21. The polishing composition of claim 20, wherein the corrosion inhibitor is triazole or benzotriazole.

22. The polishing composition of claim 1 further comprising a complexing agent that complexes with copper ions.

23. The polishing composition of claim 22, wherein the complexing agent is an organic acid.

24. The polishing composition of claim 23, wherein the organic acid is tartaric acid.

25. The polishing composition of claim 1 further comprising a polymer.

26. The polishing composition of claim 25, wherein the polymer is polyacrylic acid

27. The polishing composition of claim 1, wherein the pH of the polishing composition is about 7 or more.

28. A method of polishing a substrate comprising
(a) contacting a surface of a substrate with a polishing pad,
(b) supplying a polishing composition between the surface of the substrate and the polishing pad, wherein the polishing composition comprises abrasive particles, about 0.001-0.2 wt. % of a hydroxyquinoline, and a diamine compound comprising an ether group, and
(c) moving the polishing pad relative to the surface of the substrate to remove a portion of the substrate, thereby polishing the substrate.

29. The method of claim 28, wherein the substrate comprises copper.

30. The method of claim 29, wherein the substrate further comprises tantalum.

31. The method of claim 30, wherein the substrate is an integrated circuit.

32. The method of claim 28, wherein the hydroxyquinoline is 8-hydroxyquinoline.

33. (canceled)

34. The method of claim 28, wherein the polishing composition comprises about 0.005-0.02 wt. % of a hydroxyquinoline.

35. The method of claim 28, wherein the diamine compound comprising an ether group is a polyether diamine.

36. The method of claim 35, wherein the diamine compound comprising an ether group is a trioxa-tridecane diamine.

37. The method of claim 36, wherein the diamine compound comprising an ether group is 4,7,10-trioxa-1,13-tridecane diamine.

38. The method of claim 28, wherein the polishing composition comprises about 0.05-5 wt. % of the diamine compound comprising an ether group.

39. The method of claim 38, wherein the polishing composition comprises about 0.1-1 wt. % of the diamine compound comprising an ether group.

40. The method of claim 28, wherein the polishing composition comprises about 0.001 -0.2 wt. % 8-hydroxyquinoline and about 0.05-5 wt. % 4,7,10-trioxatridecane-1,13-diamine.

41. The method of claim 40, wherein the polishing composition comprises about 0.005-0.02 wt. % 8-hydroxyquinoline and about 0.1-1 wt. % 4,7,10-trioxatridecane-1,13-diamine.

42. The method of claim 28, wherein the polishing composition comprises about 0.1-5 wt. % abrasive particles.

43. The method of claim 42, wherein the abrasive particles are metal oxide abrasive particles.

44. The method of claim 43, wherein the abrasive particles are selected from the group consisting of silica particles, alumina particles, and ceria particles.

45. The method of claim 44, wherein the abrasive particles are condensation-polymerized silica particles.

46. The method of claim 28, wherein the abrasive particles have an average particle diameter of about 40 nm or less.

47. The method of claim 28, wherein the abrasive particle have an average particle diameter of about 40 nm or more.

48. The method of claim 28, wherein the polishing composition further comprises an oxidizing agent.

49. The method of claim 48, wherein the oxidizing agent is hydrogen peroxide.

50. The method of claim 28, wherein the polishing composition further comprises a corrosion inhibitor for copper.

51. The method of claim 50, wherein the corrosion inhibitor is triazole or benzotriazole.

52. The method of claim 28, wherein the polishing composition further comprises a complexing agent capable of complexing with copper ions.

53. The method of claim 52, wherein the complexing agent is an organic acid.

54. The method of claim 53, wherein the organic acid is tartaric acid.

55. The method of claim 28, wherein the polishing composition further comprises a polymer.

56. The method of claim 55, wherein the polymer is polyacrylic acid.

57. The method of claim 28, wherein the pH of the polishing composition is about 7 or more.
